(19) United States
(12) Patent Application Publication
(10) Pub. No.: US 2026/0001287 A1
(43) Pub. Date: Jan. 1, 2026

(54) FAULT DETECTION DEVICE

(71) Applicant: TUSAS - TÜRK HAVACILIK VE UZAY SANAYII ANONIM SIRKETI, Ankara (TR)

(72) Inventors: Seyfettin PERISAN, Ankara (TR); Dogancan ERASLAN, Ankara (TR)

(73) Assignee: TUSAS - TÜRK HAVACILIK VE UZAY SANAYII ANONIM SIRKETI, Ankara (TR)

(21) Appl. No.: 19/252,002

(22) Filed: Jun. 27, 2025

(30) Foreign Application Priority Data
Jun. 27, 2024 (TR) 2024/008229

(51) Int. Cl. B29C 70/38; B29C 70/54

(52) U.S. Cl. CPC B29C 70/384; B29C 70/54

(57) ABSTRACT

A fault detection device includes a body, a table suitable for laying, a roller located on the body, which applies pressure to the table, which rotates around itself and moves linearly on the table, and a motor located on the body for moving the roller. The body includes a dispenser disposed on the body, at least one fiber coiled on the dispenser, extending from the dispenser towards the roller and adhered and laid by pressure exerted by the roller on the table.

### CROSS REFERENCE TO THE RELATED APPLICATIONS

This application is based upon and claims priority to Turkish Patent Application No. 2024/008229, filed on Jun. 27, 2024, the entire contents of which are incorporated herein by reference.

### TECHNICAL FIELD

The present invention relates to a fault detection device for stopping production by detecting faults in composite material production machines.

### BACKGROUND

Automatic fiber laying (AFL) machines are one of the most widely used systems for the production of composite materials. These machines have a higher production capacity and fewer defects compared to manual lay-up. However, the rollers in these machines may fail over time. The most common of these failures is the accumulation of fiber and resin on the roll surface or between the plates and the formation of jams. In such cases, the roll structure deteriorates and cannot be used again in the production process. Continuous replacement of the roll can cause high financial losses. In addition, the deterioration of the roller and the plate adhesion on its surface causes various deformations in the produced part. These situations can cause losses both in terms of cost and time.

In the Japanese patent application document numbered JPH01118437A, which is included in the state of the art, the laminator system used in the production of a composite is mentioned. In the relevant document, it is mentioned that there are at least two fixed rollers and at least two moving rollers used to transfer the fibers. While the moving sensors can move in the vertical axis, it is mentioned that the movement is based on sensor data and can move in thickness.

In the European patent application document numbered EP3552809A1, which is included in the state of the art, a system that provides emergency and instant monitoring of the automatic fiber laying machine is mentioned. In the relevant document, it is mentioned that rollers are used during fiber laying and image processing is performed and production is controlled thanks to sensors and cameras that provide instant monitoring in the laying area.

### SUMMARY

Thanks to a fault detection device developed with this invention, it is possible to intervene in the production of composite parts by providing fast and effective detection of malfunctions that occur in production machines during the production of composite parts.

Another aim of the present invention is to obtain machines that enable the production of parts containing composite materials with better quality and less deformation.

Another object of the present invention is to provide machines for the production of parts containing composite materials, which are less costly and which can produce better without loss of work and time.

The first claim and the fault detection device defined in the claims dependent on this claim, which are realized in order to achieve the purpose of the invention, include a table that enables the production of parts by laying on the body. On the table is a moving roller which rotates around its own axis and at the same time moves linearly and applies pressure to the table. The roller is moved by means of a motor located on the body. There is at least one fiber coming from a distributor located on the body and flowing through the roller towards the table.

The inventive fault detection device comprises a shaft positioned on the body and opposite the roller. A switch located on the body controls the operation of the motor. In a first state (I) the motor is running, the roll is moving and the switch is closed. In a second state (II) the motor is stopped, the roll is not laying fiber on the table and the switch is open. When the fiber is wound on the roller and contacts the shaft, the shaft moves and hits the switch, triggering the switch. In this way, the switch moves from the first state (I) to the second state (II), stopping the motor and the fiber laying process of the roll.

In one embodiment of the invention, the fault detection device comprises a triggering mechanism positioned on the body between the switch and the shaft, which is triggered by the movement of the shaft, thereby triggering the switch to switch from the first state (I) to the second state (II).

In one embodiment of the invention, the fault detection device comprises a bracket positioned on the shaft on the axis on which the shaft extends, which is located in the triggering mechanism. The triggering mechanism comprises a shaft extending in parallel with the shaft, which rotates around its axis when the shaft is triggered. The bracket is located between the shaft and the shaft, ensuring that they are connected to each other. In the triggering mechanism, there is a pin that triggers the switch to switch from the first state (I) to the second state (II) by the impact of the shaft rotating around its axis.

In one embodiment of the invention, the fault detection arrangement comprises a pin that stops the motor by switching the switch from the first state (I) to the second state (II), triggered by the shaft moving the shaft. The shaft is connected to the body by means of at least two holders.

In one embodiment of the invention, the fault detection device comprises a plurality of plates positioned side by side on the roller, surrounding the cross-section of the roller, wherein the roller presses the fibers against the table. When the switch is in the first state (I), the fibers are entangled between the plates as the roller lays the fibers through the plates. At this time, the plates and the fiber contact the spindle. In this way, the spindle moves and triggers the switch to move from the first state (I) to the second state (II). By laying the fibers on the table, at least one part is produced.

In one embodiment of the invention, the fault detection device comprises a first body and a second body, between which the roller is positioned and which hold the roller at two ends and form the body. At the center of the roller is a rod which holds the roller between the first body and the second body and allows the roller to rotate. Above the roller is a cylinder on which the roller contacts the fiber and on which the plates are positioned. The motor triggers the rod, allowing the roll to move.

In one embodiment of the invention, the fault detection device comprises a laying region on a table, which includes a dispenser and a raw fiber, wherein the fiber exits the dispenser, moves towards the roller and the fiber is laid. On the table, there is a detection zone where the detection of fiber entanglement in the roll is provided with a spindle and where the spindle and the trigger mechanism are positioned.

In one embodiment of the invention, the fault detection device, when the switch is in the first state (I), the part is formed by laying the fibers coming from the distributor on the laying area towards the table by rotating the roller on its own axis and moving it linearly by rotating the motor when the switch is in the first state (I), and in the meantime, the fibers or the resin around the fibers are deposited or entangled between the plates or on the cylinder, and the thickness of the roller increases as a result of the increase in the thickness of the roller, hitting the shaft and moving the shaft. It includes the body that enables the processing of the steps of stopping the operation of the motor by moving the bracket linearly in the direction of the fixing zone with the movement of the shaft and triggering the shaft by moving with the shaft, the shaft activates the pin and the switch is triggered and brought to the second state (II) and the motor stops working and the roller, which remains fixed with the motor stopping, is removed and cleaned by the user.

In one embodiment of the invention, the fault detection device comprises a scraping blade positioned on the shaft, which removes deposits formed between the plates and on the surface of the cylinder.

In one embodiment of the invention, the fault detection device comprises a doctor blade for cleaning the plates and the cylinder when the switch is in the first state (I), thereby delaying the transition of the switch from the first state (I) to the second state (II).

In one embodiment of the invention, the fault detection device comprises a cylinder extending in parallel with the shaft, the cylinder having the same length as the shaft and being located next to the shaft.

In one embodiment of the invention, the fault detection device comprises a roller for producing and forming a part comprising a composite material.

In one embodiment of the invention, the fault detection device comprises a body in an automatic fiber laying machine.

### BRIEF DESCRIPTION OF THE DRAWINGS

The fault detection device realized to achieve the purpose of the present invention is shown in the attached figures, and from these figures;

FIG. 1—Perspective view of the fault detection device.

FIG. 2—Schematic view of the fault detection device.

FIG. 3—Schematic view of the body, roller and shaft with the switch in the first state (I).

FIG. 4—Schematic view of the body, roller and shaft with the switch in the second state (II).

The parts in the figures are numbered one by one and the corresponding numbers are given below.
1. Fault detection device
2. Body
   201. First body
   202. Second body
3. Roller
   301. Rod
   302. Cylinder
4. Engine
5. Fiber
6. Spindle
7. Switch
8. Trigger mechanism
   801. Bracket
   802. Shaft
   803. Pin
   804. Holder
9. Plate
10. Stripping knife
(I) First state
(II) Second state
(A) Laying zone
(B) Fixing zone
(D) Distributor
(P) Part
(T) Table

### DETAILED DESCRIPTION OF THE EMBODIMENTS

The fault detection device (1) comprises a body (2), a table (T) suitable for laying, a roller (3) located on the body (2), applying pressure to the table (T), rotating around itself and moving linearly on the table (T), enabling the roller (3) to be moved, the body (2) comprises a motor (4) disposed on the body (2), a dispenser (D) disposed on the body (2), at least one fiber (5) wound on the dispenser (D), extending from the dispenser (D) towards the roller (3) and being adhered and laid by pressure exerted by the roller (3) on the table (T).

The inventive fault detection device (1) comprises a spindle (6) located on the body (2) opposite the roller (3), a switch (7) located on the body (2) and controlling its operation by triggering the motor (4), a first state (I) in which the motor (4) operates and moves the roller (3), the switch (7) is closed, the motor (4) stops the roller (3) and fiber (5) laying, a second state (II) in which the switch (7) is open, the fiber (5) wound on the roller (3) and contacting the spindle (6), the spindle (6) triggering the switch (7) by the contact of the fiber (5), the spindle (6) enabling the switch (7) to move from the first state (I) to the second state (II) and stopping the motor (4) and the roller (3) from laying the fiber (5).

On the table (T) on which the laying is made on the body (2), there is a roller (3) that rotates around itself and moves linearly on the surface of the table (T) and applies pressure to the table (T). The roller (3) ensures that the fibers (5), which are raw on the dispenser (D) on the body (2) and entangled in the dispenser (D), are pressed against the table (T) and laid in rows and layers. The movement of the roller (3) is provided by the motor (4) located on the body (2).

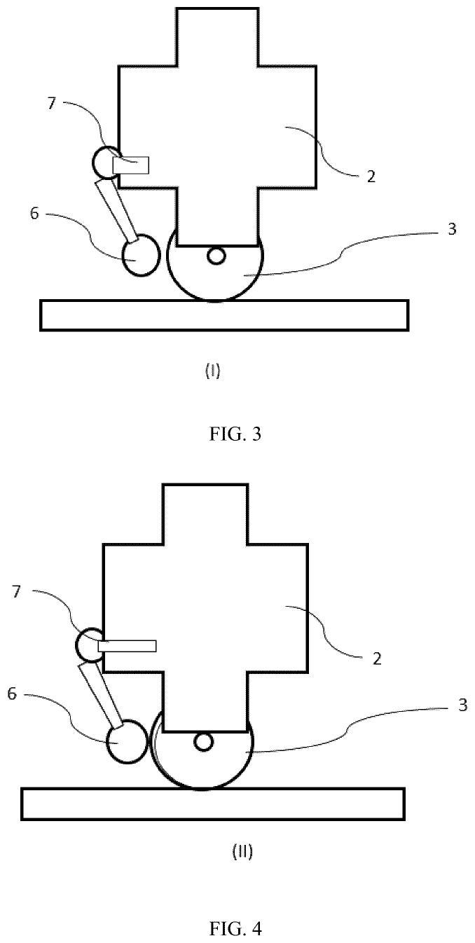

On the body (2), there is a spindle (6) side by side with the roller (3). When the spindle (6) moves, it can trigger the switch (7). The switch (7) is connected to the motor (4) which drives the roller (3) and allows the motor (4) to be stopped when necessary or in case of emergency. The switch (7) is closed in the first state (I) and allows the motor (4) to start and the roller (3) to lay the fiber (5) on the table (T). When the switch (7) is in the second state (II) it is open and the motor (4) and therefore the roller (3) stops and the fiber (5) is not laid. During laying on the roller (3), the fibers (5) may contact the spindle (6) as a result of scattered, unintentionally wound and tangled placement of the fibers (5). Thus, the distance between the roll (3) and the spindle (6) is removed. In this case, the spindle (6) moves linearly and triggers the switch (7) to move from the first state (I) to the second state (II). In this way, when the fiber (5) is not laid on the table (T) and is brought towards the spindle (6) by the roller (3), the laying is stopped immediately and the roller (3) is cleaned. (FIG. 3)

In one embodiment of the invention, the fault detection device (1) comprises a triggering mechanism (8) located on the body (2) between the switch (7) and the spindle (6), which is triggered by the movement of the spindle (6) to cause the switch (7) to move from the first state (I) to the second state (II). Thanks to the triggering mechanism (8), it is ensured that the switch (7) moves quickly from the first state (I) to the second state (II) when the spindle (6) moves. (FIG. 4)

In one embodiment of the invention, the fault detection device (1) comprises at least one bracket (801) forming the triggering mechanism (8) located on the spindle (6) in the direction in which the spindle (6) extends along its length, rotating around its own axis with the movement of the spindle (6), connected to the bracket (801) extending in parallel with the direction in which the spindle (6) extends. The triggering mechanism (8) comprises a shaft (802), a bracket (801) connecting the shaft (802) and the spindle (6), a pin (803) positioned between the shaft (802) and the switch (7) in the triggering mechanism (8), which brings the switch (7) from the first state (I) to the second state (II) by being triggered by rotation of the shaft (802) around its axis. The bracket (801) in the triggering mechanism (8) moves linearly with the spindle (6) when the fiber (5) or the roller (3) moves the shaft (3). The linear movement of the bracket (801) causes the shaft (802) in the triggering mechanism (8) to rotate around its axis. The shaft (802) rotating around its own axis activates the pin (803) located in the trigger mechanism (8) and connected to the switch (7), which brings the switch (7) from the first state (I) to the second state (II) quickly and stops the laying.

In one embodiment of the invention, the fault detection device (1) comprises a pin (803) which stops the motor (4) by triggering the switch (7) from the first state (I) to the second state (II) by the movement of the shaft (802) triggered by the spindle (6), and more than one holder (804) which enables the shaft (802) to be connected to the body (2) from at least two ends. Thanks to the movement of the pin (803), the switch (7) is triggered and the motor (4) is stopped by moving from the first state (I) to the second state (II). The shaft (802) is fixed to the body (2) by means of the holders (804).

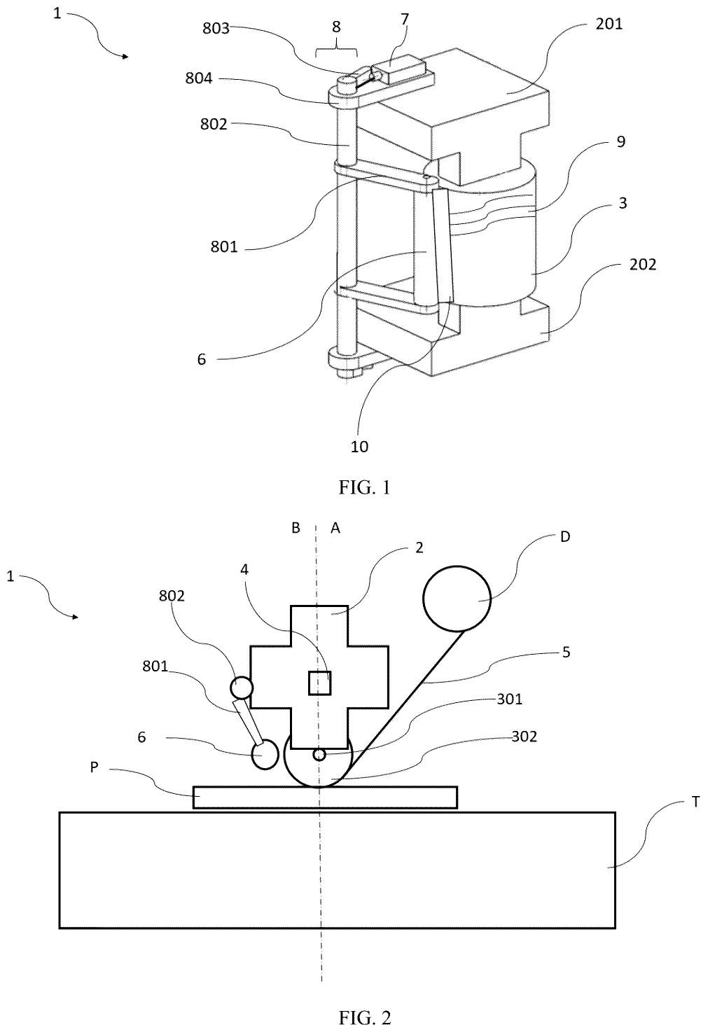

In one embodiment of the invention, the fault detection device (1) comprises a plurality of plates (9) positioned side by side on the roller (3), encircling the roller (3) transversely, on the surface of the roller (3) on which the roller (3) lays the fibers (5) by pressing them against the table (T). The switch (7) in the first state (I) contains at least one part (P) produced by laying the fibers (5) on the table (T), the fiber (5) causing the switch (7) to enter the second state (II), which is triggered by the contact of the plates (9) with the spindle (6) by the fibers (5) laid between or into the plates (9). On the surface of the roller (3) are plates (9) for laying the fibers (5) to produce parts (P) with different geometries. During laying, the fibers (5) can fill between the plates (9). Thanks to the placement of the fibers (5) between the plates (9), the plates (9) contact the spindle (6) and enable the spindle (6) to move. In this way, the spindle (6) triggers the switch (7) to move from the first state (I) to the second state (II) and stops the laying (FIG. 1).

In one embodiment of the invention, the fault detection assembly (1) comprises a first body (201) and a second body (202) forming a body (2), between which is a roller (3), holding the roller (3) at both ends, a rod (301) located in the center of the roller (3), allowing the roller (3) to rotate around the roller (3), positioning the roller (3) between the first body (201) and the second body (202). The roller (3) comprises a cylinder (302) which is located at the part of the roller (3) in contact with the plates (9), which enables the fibers (5) to be laid and pressed, which encircles the rod (301), and which is triggered by the motor (4) to rotate the cylinder (302) around its axis. The roller (3) is located between the first body (201) and the second body (202). The roller (3) is placed between the first body (201) and the second body (202) by means of the rod (301). The rod (301) is connected to the motor (4) and the roller (3) rotates as the motor (4) rotates the rod (301). Around the rod (301) is a roller (302) for laying fibers (5) and for positioning the plates (9). In this way, the fibers (5) are efficiently laid on the table (T) (FIG. 2).

In one embodiment of the invention, the fault detection device (1) is arranged on the table (T), wherein the fiber (5) exits the distributor (D) and approaches the cylinder (302), and the fiber (5) is laid by the pressing movement of the roller (3). A laying zone (A) including a dispenser (D) in which the fiber (5) is in a raw state, and a fixing zone (B) including a spindle (6) and a trigger mechanism (8), wherein the thickness formed on the cylinder (302) is detected by the spindle (6) and triggers the trigger mechanism (8). The fibers (5) coming out of the dispenser (D) are laid in the laying zone (a) by means of the roller (3). The position of the fibers (5) on the roller (302) between the plates (9) is fixed in the fixing zone (B) by moving the spindle (6) and activating the trigger mechanism (8). In this way, it is ensured that the operation of the roller (3) is stopped safely in an emergency.

In one embodiment of the invention, the fault detection device (1), when the switch (7) is in the first state (I), the motor (4) activates the roller (3) and the roller (302) rotates the rod (301) around its axis and forms the part (P) by laying the resin-coated fiber (5) extending from the distributor (D) by applying pressure on the table (T) towards the laying area (A),
While rolling, when the fibers (5) and/or the resin in which the fibers (5) are coated are filled on the surface of the cylinder (302) and/or between the plates (9) or when the fibers (5) are wrapped around the cylinder (302), the thickness of the cylinder (302) increases and the roller (3) moves by hitting the spindle (6) as a result of the height formed between it and the table (T),
As a result of the linear movement of the moving spindle (6) towards the fixing zone (B), the bracket (801), which moves linearly parallel to the movement of the spindle (6), rotates the shaft (802) around the direction in which it extends, and the pin (803) moves linearly in the angular direction in which the shaft (801) rotates and triggers the switch (7), so that the switch (7) stops the operation of the motor (4) by coming to the second state (II),
It includes a body (2) in which the motor (4) stops working and the roller (3) remains stationary on the table (T) and the steps of disassembling it by the user and cleaning it from fiber (5) and/or resin are performed. The switch (7) is closed in the first state (I) and enables the motor (4) to run, allowing the roller (3) to lay the fibers (5) coming from the distributor (D) on the table (T) in the laying zone (A).

In one embodiment of the invention, the fault detection device (1) comprises a scraping blade (10) on the spindle (6) for scraping the deposits formed on the surface of the cylinder (302) and/or between the plates (9) from the surface of the cylinder (302) or the plates (9) and removing them from the surface of the cylinder (302) and/or the plates (9). By means of the doctor blade (10), the deposits on the roller (302) and between the plates (9) are reduced. During laying, fibers (5) can be deposited between the plates (9) or on the roller (302) and move towards the fixing zone (B). In this case, the spindle (6) is activated and the bracket (801) moves linearly towards the fixing zone (B). The linearly moving bracket (801) causes the shaft (802) to rotate around its axis and moves the pin (803). The pin (803) moves and triggers the switch (7), moving it from the first state (I9) to the second state (II). When the switch (7) is in the second state (II), the motor (4) stops and the roller (3) remains stationary on the table (T). This allows the user to remove the roller (3) from the body (2) for cleaning and replacement.

In one embodiment of the invention, the fault detection device (1) comprises a stripping blade (10) for stripping the switch (7) from the surface of the cylinder (302) and/or between the plates (9) when the switch (7) is in the first state (I), delaying the switch (7) from the first state (I) to the second state (II). The stripping blade (10) delays the switching of the switch (7) from the first state (I) to the second state (II), resulting in more efficient part (P) production.

In one embodiment of the invention, the fault detection device (1) comprises a cylinder (302) extending in parallel with the direction in which the spindle (6) extends, and a cylinder (302) having the same length in the direction in which the spindle (6) extends. The size of the spindle (6) and the size of the cylinder (302) are almost the same. This ensures that no deposits on the surface of the roller (302) are missed and laying is stopped immediately when a deposit occurs.

In one embodiment of the invention, the fault detection device (1) comprises a roller (3) for forming the part (P) forming the composite material.

In one embodiment of the invention, the fault detection device (1) comprises a body (2) and a roller (3) in an automated fiber placement machine.

What is claimed is:

1. A fault detection device comprising
a body,
a table suitable for laying,
a roller located on the body, wherein the roller rotates around the roller and moves linearly on the table, the roller applies pressure to the table,
a motor located on the body to move the roller,
a distributor placed on the body,
at least one fiber, wherein the fiber is winded on the distributor, extends from the distributor towards the roller and is adhered and laid by the pressure exerted by the roller on the table, wherein the fault detection device further comprises
a spindle placed on the body opposite the roller,
a switch, wherein the switch is located on the body and controls an operation of the body by triggering the motor,
wherein in a first state, the motor starts and moves the roller and the switch is closed, in a second state, the motor stops the roller and the fiber laying and the switch is open, wherein a fiber is wound on the roller and contacts the spindle, the spindle triggers the switch by contacting the fiber, the spindle enables the switch to move from the first state to the second state and stops the motor and the roller from laying the fiber.

2. The fault detection device according to claim 1, further comprising a triggering mechanism, wherein the triggering mechanism is located on the body between the switch and the spindle, the triggering mechanism is triggered by a movement of the spindle to cause the switch to move from the first state to the second state.

3. The fault detection device according to claim 1, further comprising at least one bracket, wherein the bracket forms the triggering mechanism and is located on the spindle in a direction where the spindle extends,
a shaft is connected to the bracket, rotates around an axis of the shaft with a movement of the spindle, extends in a direction parallel to the direction where the spindle extends, and is located in the triggering mechanism,
the bracket connects the shaft and the spindle,
a pin is located in the trigger mechanism, and positioned between the shaft and the switch, wherein the pin is triggered by a rotation of the shaft around the axis of the shaft, bringing the switch from the first state to the second state.

4. The fault detection device according to claim 3, wherein the pin stops the motor by moving the spindle with triggering of the shaft, and by triggering the switch from the first state to the second state, a plurality of holders are configured for connecting the shaft to the body at least at two ends.

5. The fault detection device according to claim 1, wherein a plurality of plates are positioned side by side on the roller, encircle the roller transversely, and are positioned on a surface where the roller lays the fibers by pressing the fibers against the table, at least one part is produced by laying the fibres on the table, the fibres cause the switch to enter the second state when the switch is in the first state, triggered by a contact of the plates with the spindle by the fibres laid between or into the plates.

6. The fault detection device according to claim 5, wherein a first body and a second body form a body, the roller is between the first body and the second body, the roller is held at both ends, a rod is located in a center of the roller, allowing the roller to rotate around the rod and positioning the roller between the first body and the second body, a cylinder is located at a part of the roller in contact with the plates, the cylinder enables the fibres to be laid and pressed, encircling the rod, the rod is triggered by the motor to rotate the cylinder around an axis of the cylinder.

7. The fault detection device according to claim 6, wherein a laying zone is configured on the table, wherein the fibre exits from the distributor and approaches the cylinder and the fibre being laid by pressing movement of the roller, wherein the fibre in a raw state and the distributor are located, a fixing zone comprises the spindle and the trigger mechanism, where a thickness formed on the cylinder is detected by the spindle and triggers the trigger mechanism.

8. The fault detection device according to claim 1, wherein the body allows the following process steps to be carried out
the motor activating the roller and the cylinder rotating around its own axis by rotating the rod around its own axis and forming a part by laying resin-coated fibre extending from the distributor by applying pressure on the table towards a laying zone when the switch is in the first state,
the roller moving by hitting the spindle as a result of a height formed between the cylinder and the table due to a thickness of the cylinder increasing when the fibres and/or resin where the fibres are coated while rolling are laid on a surface of the cylinder and/or between plates or by wrapping the fibres around the cylinder,
the bracket, which moves linearly parallel to a movement of the spindle, rotating a shaft around a direction where the spindle extends, and the pin moving linearly in an angular direction where the shaft rotates and triggering the switch, wherein the switch stops an operation of the motor in the second state, as a result of linear movement of moving spindle towards a fixing zone,
the roller remaining stationary on the table and is removed by a user and cleaned from the fibre and/or resin when the motor stops running.

9. The fault detection device according to any one of claim 5, wherein a scraping blade is disposed on the spindle for scraping deposits formed on a surface of the cylinder and/or between the plates away from the surface of the cylinder and/or the plates.

10. The fault detection device according to claim 9, wherein the switch is in the first state with a scraping blade for scraping away from the surface of the cylinder and/or between the plates, and delaying the switch from the first state to the second state.

11. The fault detection device according to claim 1, wherein a cylinder extends in a direction parallel to a direction where the spindle extends, the cylinder has an identical length in the direction where the spindle extends.

12. The fault detection device according to claim 1, wherein the roller forms a part forming a composite material.

13. The fault detection device according to claim 1, wherein a body and a roller are positioned in an automated fiber placement machine.

14. The fault detection device according to claim 2, further comprising at least one bracket, wherein the bracket forms the triggering mechanism and is located on the spindle in a direction where the spindle extends,
a shaft is connected to the bracket, rotates around an axis of the shaft with the movement of the spindle, extends in a direction parallel to the direction where the spindle extends, and is located in the triggering mechanism,
the bracket connects the shaft and the spindle,
a pin is located in the trigger mechanism and positioned between the shaft and the switch, wherein the pin is triggered by a rotation of the shaft around the axis of the shaft, bringing the switch from the first state to the second state.

15. The fault detection device according to claim 2, wherein a plurality of plates are positioned side by side on the roller, encircle the roller transversely, and are positioned on a surface where the roller lays the fibers by pressing the fibers against the table, at least one part is produced by laying the fibres on the table, the fibres cause the switch to enter the second state when the switch is in the first state, triggered by a contact of the plates with the spindle by the fibres laid between or into the plates.

16. The fault detection device according to claim 3, wherein a plurality of plates are positioned side by side on the roller, encircle the roller transversely, and are positioned on a surface where the roller lays the fibers by pressing the fibers against the table, at least one part is produced by laying the fibres on the table, the fibres cause the switch to enter the second state when the switch is in the first state, triggered by a contact of the plates with the spindle by the fibres laid between or into the plates.

17. The fault detection device according to claim 4, wherein a plurality of plates are positioned side by side on the roller, encircle the roller transversely, and are positioned on a surface where the roller lays the fibers by pressing the fibers against the table, at least one part is produced by laying the fibres on the table, the fibres cause the switch to enter the second state when the switch is in the first state, triggered by a contact of the plates with the spindle by the fibres laid between or into the plates.

18. The fault detection device according to claim 2, wherein the body allows the following process steps to be carried out
the motor activating the roller and the cylinder rotating around its own axis by rotating the rod around its own axis and forming a part by laying resin-coated fibre extending from the distributor by applying pressure on the table towards a laying zone when the switch is in the first state,
the roller moving by hitting the spindle as a result of a height formed between the cylinder and the table due to a thickness of the cylinder increasing when the fibres and/or resin where the fibres are coated while rolling are laid on a surface of the cylinder and/or between plates or by wrapping the fibres around the cylinder,
the bracket, which moves linearly parallel to the movement of the spindle, rotating a shaft around a direction where the spindle extends, and the pin moving linearly in an angular direction where the shaft rotates and triggering the switch, wherein the switch stops an operation of the motor in the second state, as a result of linear movement of moving spindle towards a fixing zone,
the roller remaining stationary on the table and is removed by a user and cleaned from the fibre and/or resin when the motor stops running.

19. The fault detection device according to claim 3, wherein the body allows the following process steps to be carried out
the motor activating the roller and the cylinder rotating around its own axis by rotating the rod around its own axis and forming a part by laying resin-coated fibre extending from the distributor by applying pressure on the table towards a laying zone when the switch is in the first state,
the roller moving by hitting the spindle as a result of a height formed between the cylinder and the table due to a thickness of the cylinder increasing when the fibres and/or resin where the fibres are coated while rolling are laid on a surface of the cylinder and/or between plates or by wrapping the fibres around the cylinder,
the bracket, which moves linearly parallel to the movement of the spindle, rotating the shaft around the direction where the spindle extends, and the pin moving linearly in an angular direction where the shaft rotates and triggering the switch, wherein the switch stops an operation of the motor in the second state, as a result of linear movement of moving spindle towards a fixing zone,
the roller remaining stationary on the table and is removed by a user and cleaned from the fibre and/or resin when the motor stops running.

20. The fault detection device according to claim 4, wherein the body allows the following process steps to be carried out
the motor activating the roller and the cylinder rotating around its own axis by rotating the rod around its own axis and forming a part by laying resin-coated fibre extending from the distributor by applying pressure on the table towards a laying zone when the switch is in the first state,
the roller moving by hitting the spindle as a result of a height formed between the cylinder and the table due to a thickness of the cylinder increasing when the fibres and/or resin where the fibres are coated while rolling are laid on a surface of the cylinder and/or between plates or by wrapping the fibres around the cylinder,
the bracket, which moves linearly parallel to the movement of the spindle, rotating the shaft around the direction where the spindle extends, and the pin moving linearly in an angular direction where the shaft rotates and triggering the switch, wherein the switch stops an operation of the motor in the second state, as a result of linear movement of moving spindle towards a fixing zone,
the roller remaining stationary on the table and is removed by a user and cleaned from the fibre and/or resin when the motor stops running.
